(19) United States
(12) Patent Application Publication
(10) Pub. No.: US 2017/0156365 A1
(43) Pub. Date: Jun. 8, 2017

(54) DEPOSITED CHEWING GUM PRODUCT

(71) Applicant: WM. WRIGLEY JR. COMPANY, CHICAGO, IL (US)

(72) Inventors: Martin R. CERVENKA, Chicago, IL (US); David R. PHILLIPS, Downers Grove, IL (US); Scott G. BROWN, Oswego, IL (US); Michael CATIZONE, Plainfield, IL (US)

(73) Assignee: WM. WRIGLEY JR. COMPANY, CHICAGO, IL (US)

(21) Appl. No.: 15/039,057

(22) PCT Filed: Nov. 24, 2014
(86) PCT No.: PCT/US14/67126

§ 371 Date: May 25, 2016

Related U.S. Application Data
(60) Provisional application No. 61/909,022, filed on Nov. 26, 2013.

(51) Int. Cl. A23G 4/18; A23G 4/06

(52) U.S. Cl. CPC A23G 4/18; A23G 4/06

(57) ABSTRACT

The present invention describes a process wherein a liquid chewing gum is deposited onto a surface to form deposits of a chewing gum product. The individual deposits of chewing gum can then undergo further packaging and wrapping to form a commercially acceptable chewing gum product.

The present invention relates to chewing gum. More specifically, the present invention relates to a process wherein a liquid chewing gum is deposited onto a surface to form deposits of chewing gum product. The surface can be a packaging material, a conveyor belt or manufacturing roll, or any other substantially flat material. These deposits of chewing gum product can be either individual deposits forming individual pieces of chewing gum product or they can form a continuous ribbon of deposited chewing gum that can be cut into individual pieces of chewing gum product. The chewing gum product of the present invention can then undergo packaging for commercial retail. The process of the current invention improves overall efficiency in a factory by eliminating several steps used in the production of a finished packaged chewing gum product. The equipment necessary for the process of the current invention is also more compact and takes up less space than the equipment necessary for preparing a traditional finished packaged chewing gum product. The present invention also introduces a new form of chewing gum since the consumer could peel the individual deposits of chewing gum product off of the packaging material for consumption. The present invention could also be consumed similarly to the consumption of traditional chewing gum products wherein the liquid chewing gum could release from the packaging on its own without the need to peel. The individual pieces of the chewing gum product can also be sold together in bags or other packaging.

Typically, traditional chewing gum products are either packaged individually or coated to prevent the individual pieces of chewing gum from sticking together. A typical packaged uncoated chewing gum product sold in stores contains a finished chewing gum product, packaging material surrounding individual pieces of chewing gum to keep the individual pieces from sticking or melting together, and a packaging material holding multiple pieces of the coated chewing gum or wrapped chewing gum pieces together in a single package for commercial resale. The chewing gum product of the present invention does not require the same amount of packaging material as traditional uncoated chewing gum as it can be deposited directly onto a strip of packaging material, rather than the packaging material surrounding the entire uncoated chewing gum piece, and then the strips of packaging material containing the chewing gum can be wrapped in a larger material (for hygienic reasons) for commercial resale. As mentioned, another method used to prevent traditional chewing gum pieces from sticking together is to coat the chewing gum. The coating process makes the outside of the chewing gum product less sticky thus allowing for several pieces of chewing gum product to be packaged together without sticking or melting together. The present invention makes the coating process unnecessary, but possible if desired.

The manufacture of traditional chewing gum products also requires a factory setting with equipment that takes up a large amount of space. The present invention allows for the manufacture of chewing gum in a small or compact space—for example one that could be contained in a small room or even on a table top. The need for less space would thus allow for manufacturing outside of a typical factory setting and would allow for the set up of equipment in several locations that would not be able to accommodate typical factory equipment. The present invention could be a portable factory. This would allow for the spread of chewing gum manufacture to areas and locations where it has not been possible to build large scale factories, including but not limited to remote locations, trade shows, franchises, stores, and restaurants.

The typical chewing gum manufacturing process includes a mixer and/or extruder, sheeting line, tempering areas, and a wrapping process. The chewing gum product of the current invention can be manufactured using a simplified continuous process that could eliminate the need for a traditional extruder, a rolling and scoring line, cooling, tempering, and coating or packaging of the individual chewing gum pieces. The elimination of one or more of these steps increases overall efficiency during manufacture of the finished chewing gum product by greatly reducing the number of unit operations and handling. The present invention could also help to simplify the packaging process by combining the forming and wrapping processes used in the manufacture of traditional chewing gum products. The process for manufacturing the chewing gum product of the present invention requires less steps allowing for the manufacture of the present invention on a much more compact level than traditional manufacture of chewing gum products and can thus be manufactured in a much smaller space. These simplifications also help make the manufacturing process more sustainable by using less energy, equipment, and packaging materials.

The liquid chewing gum of the present invention is manufactured by combining chewing gum base or chewing gum base ingredients with other common chewing gum ingredients to form a substantially finished chewing gum product which is in liquid form. A liquid form means a material in a form and viscosity such that the material is stable at low viscosity, but able to flow and take the shape of a container. The liquid chewing gum product of the present invention is then deposited directly onto a surface underneath the depositing device to form deposits. The deposits can be either individual deposits of chewing gum product on the surface or a continuous ribbon of any width or thickness that can later be cut to the desired piece size. As previously stated, the surface can be any type of packaging material, a conveyor belt or manufacturing roll, or any substantially flat material. The packaging material can be a substantially flat film or other packaging material including but not limited to blister packs, tape, and sachets. The liquid chewing gum deposits turn from liquid form to solid form during the depositing process when the chewing gum is within the viscosity index (defined later in the application) and the parameters of the process (temperature, system pressure, diameter of opening(s) of depositing device, distance of depositing device from the surface) are appropriate as described later. By solid form it is meant that the chewing gum is structurally rigid and resistant to change in shape or volume. The solid form may have some give when pressed or it may be hard and brittle. The solid chewing gum product does not flow or take on the shape of its container as the liquid chewing gum does; rather it remains a cohesive mass and substantially retains the shape of the deposit when deposited onto the surface. The deposited chewing gum of the present invention can also be double deposited for a bulls eye effect or deposited in a continuous strip, layers, stripes, etc. and then cut and sealed together. The chewing gum of the present invention can be deposited into any form, shape, or size allowable by the equipment.

This invention is directed to a novel chewing gum process wherein a liquid chewing gum is deposited onto a surface to form deposits of solid chewing gum product which can then undergo further processing and packaging to prepare the one or more deposits of chewing gum product for commercial retail. The process of the current invention requires less space and is more compact than traditional chewing gum processes. The chewing gum product of the present invention also introduces a potentially new way for the consumer to consume chewing gum.

The process of the present invention involves creating a liquid chewing gum which is then deposited onto a surface to form deposits of solid chewing gum product on the surface. The liquid chewing gum is comprised of a chewing gum base or base ingredients and other common chewing gum ingredients mixed together and in a liquid form. The surface can be a packaging material, a conveyor belt or manufacturing roll, or any other substantially flat material. The packaging material can be a substantially flat film or any other typical packaging material used in the manufacture of commercial chewing gum including but not limited to blister packs, tape, and sachets. When the liquid chewing gum is deposited onto the surface each deposit forms a solid chewing gum product. These deposits of chewing gum products can then undergo further processing and/or packaging for commercial retail. When chewed the deposited chewing gum product of the present invention remains a cohesive mass and produces a chew similar to that of a typical commercial chewing gum.

The present invention provides a more efficient way of producing chewing gum. The process of the current invention eliminates both steps and material from the typical commercial chewing gum process. The process of the current invention can eliminate the need for coating of a chewing gum product as well as several manufacturing steps. Coating processes are typically used to coat individual chewing gum pieces to prevent the pieces from sticking or melting together. The present invention makes the coating process unnecessary, but possible if desired. With regards to manufacturing, a traditional chewing gum manufacturing process can involve a mixer or extruder, sheeting line, tempering areas, and several wrapping steps to ensure the individual chewing gum pieces do not stick to each other. The present invention simplifies manufacturing as it can eliminate the need for one or more manufacturing steps including but not limited to a traditional extruder and sheeting and tempering area and simplifies the steps involved in forming and wrapping the chewing gum.

The process of the current invention also helps reduce the capital cost for entering the market and producing chewing gum. Additionally the process of the current invention can be very compact and simple to use, thus taking up little space in a factory and allowing the process to be operated by a single person. The compact size and simple use could allow the process to be used in areas and places where typical factories are not practical. For example the process of the present invention would allow for a portable factory or a factory in a box that could be used in remote locations, at trade shows, by franchisees, and restaurants. It also gives consumers a new way of consuming chewing gum since the consumer can peel the individual deposits of chewing gum product off the packaging material in order to consume it. The chewing gum product of the present invention can also be consumed in more traditional ways where the chewing gum releases from the wrapper without peeling or pieces of it are pulled from a bag.

The process of the present invention is a continuous process of depositing liquid chewing gum onto a surface to form deposits of chewing gum product on the surface. These individual deposits change from liquid to solid form once they are deposited on the surface. The deposits form a solid chewing gum product which remains a cohesive mass when chewed. The solid chewing gum product can then undergo further processing or packaging. Further packaging can allow for sanitary distribution and sale in stores and other retail centers. The further packaging may include any of several packaging processes currently used in the chewing gum and confectionery industry.

The process of the present invention is comprised of a device for mixing of the chewing gum base with other chewing gum ingredients to create a substantially complete gum in liquid form and a device for depositing the liquid chewing gum onto a surface to form deposits of chewing gum on the surface. The process of the present invention can also include heating or cooling elements for maintaining the liquid chewing gum at a desired temperature and pumps for moving the liquid chewing gum through the devices. Other devices commonly used in the manufacture of chewing gum can also be included in the process, including but not limited to extruders, mixers, blenders, conveyor belts, manufacturing rolls, controllers, wrapping machines, and hoses.

An example of the current process is a system which includes a mixing tank, which can be heated, for mixing the chewing gum base or other chewing gum ingredients to create a substantially complete chewing gum in liquid form, a pump which then pumps the liquid chewing gum from the mixing tank to a depositing device through a hose (which can be heated), and the depositing device for depositing the liquid chewing gum onto a type of surface to form deposits of chewing gum in solid form on the surface (“chewing gum product”). The depositing device may have one or more nozzles for depositing the liquid chewing gum. The system can also include a controller for helping control the pump pressure. As previously mentioned the liquid chewing gum product can be deposited onto the surface to form individual deposits or a continuous ribbon of a desired width and thickness. If the liquid chewing gum product is deposited onto packaging material to form individual deposits of chewing gum product, the packaging material containing the individual deposits of chewing gum product can then be cut and wrapped using a wrapping machine. The packaging material containing the chewing gum product can be cut into strips containing one or more individual deposits of chewing gum product. The strips containing one or more individual deposits of chewing gum product can then be wrapped in additional packaging material using traditional packaging and/or wrapping methods. The one or more chewing gum products can be wrapped in a single wrapper or package wherein the individual deposits of chewing gum product are the same or different materials. If the liquid chewing gum product is deposited in a continuous ribbon, it can then be cut into the desired piece size and wrapped/packaged if desired.

There are several factors that can affect the depositing process and the ability to deposit the liquid chewing gum onto the surface to form commercially acceptable chewing gum products at high rates. The factors that need to be considered in making a commercially acceptable product by the process of the current invention include the depositing time of each deposit for efficiency, piece size uniformity for commercial acceptance, depositing temperature for efficiency and to prevent loss of or deterioration of ingredients, tailing at the end of each deposit for commercial acceptance, and the shape of each individual deposit for commercial acceptance. In the present invention, when making individual deposits of chewing gum rather than a continuous ribbon, it is important to minimize the depositing time of each individual deposit, ensure piece size uniformity, minimize depositing temperature, control tailing at the end of each deposit, and control the shape of the individual deposits.

The depositing time of each individual deposit of liquid chewing gum needs to be minimized. This depositing time is controlled by the viscosity of the liquid chewing gum, the diameter of the one or more openings in the depositing device, the system pressure, and the desired piece size for the individual deposits. The viscosity of the liquid chewing gum needs to stay within the viscosity index. The viscosity index is the range of viscosity the liquid chewing gum can have which allows the liquid chewing gum to move through the system and be deposited onto the surface through the depositing device, but also forms a solid chewing gum having a specific shape (including but not limited to a flattened shape, circle, oval, ball, rectangle, rope, dollop, layer, or square) upon making contact with the surface without leaking off the surface during the process. The viscosity index also needs to be such that it minimizes tailing and stringing of the liquid chewing gum after each individual deposit of liquid chewing gum onto the surface.

The viscosity index is controlled by the depositing temperature and formulation of the liquid chewing gum. Depositing temperature means the temperature of the liquid chewing gum at the time the liquid chewing gum is being deposited onto the surface. The depositing temperature must be such that the liquid chewing gum maintains the viscosity index for the particular formulation but not so high or low that it causes undesired side effects. If the depositing temperature is too low the liquid chewing gum will have a high viscosity (be too viscous) and not flow freely through the system and depositing device. Instead, the liquid chewing gum will solidify and stick to the depositing device or other equipment clogging it rather than passing through or greatly increase the depositing time thus reducing the machine speed. However, a lower temperature is most desired because it is safer and more efficient to operate and allows for more options when considering product formulation or the surface one is depositing onto since the formulations and surface will need to withstand the depositing temperature.

On the other hand, a depositing temperature that is too high would cause the liquid chewing gum to have a viscosity that is too low (not viscous enough) and the liquid chewing gum would flow too freely through the system and depositing device. At a high depositing temperature the liquid chewing gum would leak off the surface once deposited onto through the depositing device. The liquid chewing gum would also have a hard time forming a solid chewing gum mass fast enough on the surface.

Other undesired effects of a high depositing temperature include browning of certain ingredients or volatilization of flavors contained in the chewing gum. It is desirable to use fruit flavors and other non-fruit flavors commonly used in chewing gum products in the process of the current invention. However, higher depositing temperatures require specialty flavors to avoid volatilization. Flavors help to plasticize the chewing gum thus keeping the viscosity down. At higher temperatures as the flavor volatilizes over time, the viscosity of the liquid chewing gum would naturally begin to increase causing the deposit volume to go down causing an inconsistency in the final chewing gum product form and size. Deposit volume is defined as the volume of liquid chewing gum deposited onto the surface. Other things to consider are the effects of temperature on other components of the chewing gum formulation including the plasticity of the chewing gum base and the crystallization of sweeteners and other chewing gum ingredients. Additionally a higher depositing temperature requires a surface, such as packaging materials, that are appropriate for processing at higher temperatures and thus these surfaces would require even higher temperatures for sealing and further packaging which raises costs and increases operational time. In some embodiments of the present invention the depositing temperature ranges from 50° C. to 130° C. However, it is preferred that the depositing temperature ranges from 70° C. to 120° C. and it is most preferred that the depositing temperature ranges from 80° C. to 110° C.

The depositing time can also be minimized by increasing system pressure or increasing the diameter of the opening or openings in the depositing device from which the liquid chewing gum exits the depositing device and is deposited onto the surface. Increasing the pump pressure allows the liquid chewing gum to flow through the system more quickly because the higher the system pressure the greater the output of the depositing device while the opening in the depositing device is open. The diameter of the opening or openings of the depositing device must also be large enough to allow a substantial amount of liquid chewing gum through the opening or openings, but small enough that not too much liquid chewing gum is deposited onto the surface causing it to leak off the surface. Since the size of the opening also controls the shape and size of the final product the diameter of the opening or openings cannot be too large.

To ensure that the chewing gum product of the present invention is commercially acceptable there needs to be uniformity in size of the individual deposits of chewing gum product. In order to control the size of the deposit the system must be designed to hold a constant pressure during operation. By maintaining constant pressure in the system every time the opening in the depositing device opens a uniform amount of liquid chewing gum is deposited onto the surface. Constant pressure can be maintained in the system by several means which may include running the pump continuously with a return loop and a controller device. It would not be recommended to run the system with a pump that has pulsing action, such as a piston pump, as the pressure in the system would vary with each pulse rather than remaining constant.

As previously mentioned a significant factor in depositing the liquid chewing gum at a commercially acceptable level is the depositing temperature. Temperature is very important in achieving a viscosity within the viscosity index. Also as previously mentioned it is important to minimize the depositing temperature as it reduces the cost of materials and allows for more options since there is a lower risk of melting packaging material or browning or volatilizing ingredients in the chewing gum formulation.

The control of tailing at the end of each individual deposit of liquid chewing gum onto the surface is also very important in creating the final commercial chewing gum product. Tailing can be described as the creation of a tail or string at the end of each individual liquid chewing gum deposit. The preferable way of minimizing and controlling tailing is by adjusting the formulation to make it less likely to cause a tail or string effect. Another way to control the tailing at the end of the individual deposit is to raise the deposit temperature; however, as previously explained there are many limitations on running the system at higher temperatures. Tailing can also be reduced or eliminated by moving the depositing head with the deposited piece or by using a nozzle or other depositing device that has no cavity thus pushing all the liquid chewing gum out with every stroke. This helps to reduce the tailing if not fully eliminate it.

One of the most important aspects of selling a commercially acceptable chewing gum product is the shape of it and keeping that shape uniform for all pieces. The individual deposits of chewing gum described in the present invention can be deposited so as to form various shapes. A nozzle or opening in the depositing device can be shaped into a particular form so as to deposit the liquid chewing gum onto the surface in a specific way. The shape of the deposits can also be controlled by adjusting the relationship between the line speed and depositing time. Some possible shapes for the individual deposits of chewing gum include a flattened shape, circle, oval, ball, rectangle, rope, dollop, layer, or square. The preferable shape is a circle. Even with a predetermined shape adjustments can be made to the depositing device to alter the shape a bit. For instance, the closer the nozzle or other depositing device is to the surface the more circular the shape. The shorter the opening time of the depositing device the less oval and more circular the deposit. The depositing device can also be moved along with a surface being deposited onto to make the individual deposit more circular. This can be done with a linear actuator or other device. The surface can also be moved intermittently (start stop) with each deposit. Such intermittent movement would also help reduce stringing.

As previously mentioned the chewing gum product of the present invention can be produced by depositing the liquid chewing gum onto a surface (which may be chilled) in a continuous ribbon rather than as individual deposits. The continuous ribbon is considered one deposit. The viscosity index of the liquid chewing gum would need to be such that the continuous ribbon not leak off the surface as it is deposited, but still form a solid chewing gum product that can be spread to a desired width and thickness. A dam and gates can be used to spread the liquid chewing gum out to the desired width and thickness. This continuous ribbon can then be cute into the desired piece size and wrapped. This embodiment eliminated the need for a traditional sheeting line as well as cooling and tempering.

The process used to deposit the liquid chewing gum onto the surface can be repeated to form a second or multiple layers of individual deposits on the original deposits forming the chewing gum products. These layers can be the same size and shape as the previous layer or a different size or shape. These layers can also vary in color, flavor, and formulation from the original layer. These layers do not need to be another layer of liquid chewing gum. They can also be layers of chocolate, hard candy, chewy candy, sweetener, color, flavor or other chewing gum ingredients. Such layers can add texture, color, shape or design to the original individual deposits of liquid chewing gum.

The process can also include a deposit of a food approved substance onto the surface prior to depositing the first layer of deposits of liquid chewing gum. This deposit could be a material used to pretreat the surface prior to the deposit of liquid chewing gum, for example to alter the properties of a packaging material in order for the deposits to occur at a higher temperature or cause the liquid chewing gum to solidify more quickly. This deposit could also be used to add various properties to the chewing gum, such as taste, flavor, color, design, acid, actives, capsule, and secondary imbedded food of confectionery materials.

The surface can also be pretreated in some other manner prior to the deposit of the liquid chewing gum. For instance the surface can be chilled or heated depending on the desired effect for depositing the liquid chewing gum. A food approved substance can also be applied to the entire surface to aid in different elements of the manufacturing.

The formulation of the liquid chewing gum of the present invention can be similar to the formulations of typical chewing gums currently being manufactured or novel formulations of chewing gum that are currently being or will be developed in the future. The process of the current invention will need to be adjusted for every new formulation used in the process so as to ensure the viscosity of the liquid chewing gum is within the viscosity index.

In general, a typical chewing gum composition contains a chewable gum base portion which is essentially free of water and is water-insoluble, a water-soluble bulk portion and flavors which are typically water insoluble. The water-soluble portion dissipates with a portion of the flavor over a period of time during chewing. The gum base portion is retained in the mouth throughout the chew.

The insoluble gum base generally comprises elastomers, elastomer solvents, plasticizers, waxes, emulsifiers and inorganic fillers. Plastic polymers, such as polyvinyl acetate, which behave somewhat as plasticizers, are also often included. Other plastic polymers that may be used include polyvinyl laureate, polyvinyl alcohol and polyvinyl pyrrolidone.

Elastomers may include polyisobutylene, butyl rubber, (isobutylene-isoprene copolymer) and styrene butadiene rubber, as well as natural latexes such as chicle. Elastomer solvents are often resins such as terpene resins and rosin esters. Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

According to the preferred embodiment of the present invention, the insoluble gum base constitutes between about 5% to about 95% by weight of the gum. More preferably the insoluble gum base comprises between 10% and 50% by weight of the chewing gum and most preferably about 20% to 35% by weight of the chewing gum.

The gum base typically also includes a filler component. The filler component may be calcium carbonate, magnesium carbonate, talc, dicalcium phosphate or the like. The filler may constitute between about 5% and about 60% by weight of the gum base. Preferably the filler comprises about 5% to 50% by weight of the gum base.

Gum base typically also contains softeners including glycerol monostearate and glycerol triacetate. Gum bases may also contain optional ingredients such as antioxidants, colors, and emulsifiers. The present invention contemplates employing any commercially acceptable gum base.

The water-soluble portion of the chewing gum may be comprised of plasticizing agents, fillers, softeners, colors, flavors, antioxidants, emulsifiers, sweeteners (including high-intensity sweeteners), acidulants, sensates, other conventional non-elastomeric gum base components, pharmaceuticals or nutraceutical agents, and combinations thereof. Although these ingredients are typically found in the soluble portion of a chewing gum, they can also be added to the insoluble portion of the chewing gum. Other optional ingredients, not mentioned herein, can also be added to either the soluble or insoluble portions of the chewing gum.

Sweeteners or sugar often fulfill the role of bulking agents in the chewing gum. Such bulking agents include, but are not limited to, polyols such as isomalt, maltitol, xylitol, lactitol, sorbitol, non-crystallizing syrup, and mixtures thereof. The bulking agents typically comprise about 5% to about 95% of the gum composition.

Softeners are added to the chewing gum in order to optimize the chewability and mouth feel of the gum. Softeners, also known in the art as plasticizers or plasticizing agents, generally constitute between about 0.5% to about 15% of the chewing gum. Softeners contemplated by the present invention include glycerin, lecithin and combinations thereof. Further, aqueous sweetener solutions such as those containing sorbitol, hydrogenated starch hydrolysate, corn syrup and combinations thereof may be used as softeners and binding agents in gum.

The formulation for the liquid chewing gum used in the process of the present invention may be a sugarless gum formulation. However, formulations containing sugar are also within the scope of the invention. Sugar sweeteners generally include saccharide-containing components commonly known in the chewing gum art which comprise, but are not limited to, sucrose, dextrose, maltose, dextrin, dried invert sugar, fructose, galactose, corn syrup solids and the like, alone or in any combination.

The liquid chewing gum used in the process of the present invention can also be used in combination with sugarless sweeteners. Generally sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination

Depending on the particular sweetness release profile and shelf-stability needed, free or encapsulated high-intensity sweeteners may be used in the liquid chewing gum composition. Examples of high intensity sweeteners that may be used in the liquid chewing gum are: aspartame, saccharin, Thaumatin, alitame, saccharin salts, sucralose, Stevia, and acesulfame K. Overall, the chewing gum composition will preferably comprise about 0.5% to about 90% sweetening agents. Most typically the sweetening agents will comprises at least one bulk sweetener and at least one high-intensity sweetener.

Optional ingredients such as colors, emulsifiers, nutraceuticals, supplements and pharmaceutical agents may also be added as separate components of the chewing gum composition, or added as part of the gum base.

The compositions and methods of the present invention are capable of being incorporated in the form of a variety of embodiments, only a few of which have been illustrated and described above. The invention may be embodied in other forms without departing from its spirit or essential characteristics. The described embodiments are to be considered in all aspects only as illustrative and not restrictive, and the scope of the invention; therefore, is indicated by the amended claims rather than the foregoing description. All changes which come within the meaning and range of equivalency of the claims are to be embraced within their scope.

1. A process for making a chewing gum product wherein a liquid chewing gum is deposited onto a surface to form a solid chewing gum product.

2. The process of claim 1 wherein the surface is a packaging material.

3. The process of claim 2 wherein the packaging material is a substantially flat film.

4. The process of claim 2 wherein the packaging material is a blister type package designed to give the deposited gum a specific shape.

5. The process of claim 1 wherein the liquid chewing gum comprises a chewing gum base primarily comprised of polyvinyl acetate.

6. (canceled)

7. The process of claim 1 wherein the process is a continuous process of depositing liquid chewing gum onto a surface to form individual deposits of chewing gum product.

8. The process of claim 1 wherein the process is a continuous process of depositing liquid chewing gum onto a surface to form a continuous ribbon of chewing gum product.

9. (canceled)

10. The process of claim 1 further comprising wrapping and packaging the chewing gum product.

11. A process for making a chewing gum product wherein:
a. chewing gum ingredients are combined in a device and heated to form a liquid chewing gum; and
b. the liquid chewing gum is deposited through a depositing device onto a surface to form individual deposits of chewing gum product.

12. A process for making a chewing gum product wherein:
a. chewing gum ingredients are combined to form a liquid chewing gum in a tank that controls temperature of the liquid chewing gum;
b. the liquid chewing gum is transferred to a depositing device through a hose using a pump or a pressurized system;
c. the liquid chewing gum is deposited onto a surface through a depositing device at a depositing temperature to form individual deposits of chewing gum product; and
d. the surface containing the individual deposits of chewing gum product is cut and wrapped using a wrapping machine.

13. The process of claim 12 wherein a pump and a controller control the pressure within the system.

14. The process of claim 12 wherein the diameter of at least one opening in the depositing device, where the liquid chewing gum exits the depositing device, ranges from 0.3 mm to 3.0 mm.

15. The process of claim 12 wherein the depositing temperature is between 50° C. and 130° C.

16. The process of claim 12 wherein the depositing temperature or formulation of the liquid chewing gum is modified for controlling the viscosity index and to minimize tailing of the liquid chewing gum.

17. The process of claim 12 wherein the shape of the individual deposits of chewing gum product can vary, the shape being controlled by the distance of the depositing device to the surface or the size of the opening in the depositing device.

18. The process of claim 12 wherein at least one layer of liquid chewing gum or chewing gum ingredients is deposited onto the individual deposits of chewing gum product.

19. (canceled)

20. The process of claim 12 wherein the surface undergoes pretreatment prior to the step of depositing the liquid chewing gum onto the surface.

21. The process of claim 20 wherein the pretreatment includes spraying the surface with a food approved substance.

22. The process of claim 21 wherein a food approved substance is deposited onto the surface through a depositing device.

23. The process of claim 12 wherein the chewing gum product comprised of a chewing gum composition adhered to a packaging material wherein the chewing gum composition must be peeled off the packaging material by the consumer for consumption.
